(19) United States
(12) Patent Application Publication
(10) Pub. No.: US 2006/0068201 A1
(43) Pub. Date: Mar. 30, 2006

(54) Fire resistant polymeric compositions

(76) Inventors: Graeme Alexander, Hampton East (AU); Yi-Bing Cheng, East Burwood (AU); Robert Paul Burford, Summer Hill (AU); Robert Shanks, Glen Iris (AU); Jaleh Mansouri, Rosebery (AU); Antoietta Genovese, Sandringham (AU); Kenneth Willis Barber, Little River (AU); Pulahinge Don Dayananda Rodrigo, Doncaster (AU); Vincent Patrick Dowling, East Bentleigh (AU); Lee Joy Russell, Moonee Ponds (AU); Ivan Ivanov, Ascot Vale (AU)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/531,549

(22) PCT Filed: Oct. 17, 2003
(86) PCT No.: PCT/AU03/01383

§ 371 Date: Oct. 27, 2005

(30) Foreign Application Priority Data
Oct. 17, 2002 (AU) 2002952136
Jun. 30, 2003 (AU) 2002903345

(51) Int. Cl. B32B 18/00; B32B 19/00

(52) U.S. Cl. 428/357; 428/293.4; 428/325

(57) ABSTRACT

A fire resistant composition for forming a fire resistant ceramic at elevated temperatures, the composition comprising: at least 15% by weight based on the total weight of the composition of a polymer base composition comprising at least 50% by weight of an organic polymer; and at least 20% by weight based on the total weight of the composition of a silicate mineral filler; wherein upon exposure to an elevated temperature (experienced under fire conditions), the fire resistant composition is useful for passive fire protection applications, particularly cables, the fluxing oxide is present in an amount of from 1 to 15% by weight of the residue.

### FIELD OF THE INVENTION

The present invention relates to polymeric compositions which have useful fire resistant properties and which may be used in a variety of applications. The invention also relates to the preparation of such compositions and to their use. The present invention is illustrated with particular reference to electric cables, although it will be appreciated that the invention is more widely useful in the light of the associated benefits described herein.

### BACKGROUND

Passive fire protection of structures and components is an area that is receiving increased attention. In this context the term “passive” means the use of materials that impart fire resistance. Passive fire protection systems are used extensively throughout the building and transportation industries and typically function by counteracting the movement of heat and/or smoke, by sealing holes, by prolonging stability of structures to which the system is applied and/or by creating thermal and/or physical barriers to the passage of fire, heat and smoke.

For many applications it is desirable that a material used to impart fire-resistance exhibits limited, and preferably no, substantial change in shape following exposure to the highest temperatures likely to be encountered in a fire situation (generally about 1000° C.). If the material shrinks significantly, its integrity is likely to be compromised and it may also crack and/or fracture. In turn this can lead to a breakdown in thermal and electrical insulation and a loss of fire barrier properties and fire resistance. As will be apparent from the following, for many fire resistant polymeric compositions their inherent shrinkage on exposure to elevated temperature is an accepted consequence of use. Specific measures taken to address this problem include the addition of intumescing agents, which cause expansion but provide a very mechanically weakened residue, or engineering design solutions which add to the cost of the final product or structure.

Electric cables applications typically consist of a central conductor surrounded by at least an insulating layer. Such cables find widespread use in buildings and indeed form the basis for almost all electric circuits in domestic, office and industrial buildings. In some applications, e.g. in emergency power supply circuits, there is a requirement for cables that continue to operate and provide circuit integrity even when subjected to fire, and there is a wide range of standards for cables of this type. To meet some of these standards, cables are typically required to at least maintain electrical circuit integrity when heated to a specified temperature (e.g. 650, 750, 950, 1050° C.) in a prescribed manner and for a specified time (e.g. 15 min., 30 min., 60 min., 2 hours). In some cases the cables are subjected to regular mechanical shocks during the heating stage. For example, they may be subjected to a water jet or spray either in the later stages of the heating cycle or after the heating stage. To meet a given standard a cable is typically required to maintain circuit integrity throughout the test. Thus it is important that the insulation maintains low conductivity (even after prolonged heating at high temperatures), maintains its shape so it does not shrink and crack, and is mechanically strong, particularly if it is required to remain in place during shock such as that resulting from mechanical impact due to water jet or spray exposure. It is also desirable that the insulation layer remaining after heating resists the ingress of water if the cable is required to continue operating during exposure to water spray for brief periods.

One method of improving the high temperature performance of an insulated cable has been to wrap the conductor of the cable with tape made with glass fibres and coated with mica. Such tapes are wrapped around the conductor during production and then at least one insulative layer is applied. Upon being exposed to increasing temperatures, the outer layer(s) are degraded and fall away, but the glass fibres hold the mica in place. These tapes have been found to be effective for maintaining circuit integrity in fires, but are quite expensive. Further, the process of wrapping the tape around the conductor is relatively slow compared with other cable production steps, and thus wrapping the tape slows overall production of the cable, again adding to the cost. A fire resistant coating that could be applied during the production of the cable by extrusion, thereby avoiding the use of tapes, would be desirable.

A variety of materials have been used to impart fire resistance to structures and components, including electric cables. The use of compositions based on silicone elastomers has been widespread. However, silicone elastomers can be expensive, have relatively poor mechanical properties and can be difficult to process, for example by extrusion techniques. Furthermore, these compositions tend to have the associated disadvantage that they are converted to powdery substances when exposed to fire because the organic components of the silicone elastomers are pyrolised or combusted. The pyrolysis or combustion products are volatilised and leave an inorganic residue or ash (silicon dioxide) that has little inherent strength. This residue is generally not coherent or self-supporting and indeed is often easily broken, dislodged or collapsed. This behaviour mitigates against using silicone elastomers as passive fire protection elements. This means, for instance, that silicone polymers used as insulation on electric cables must be protected and held in place with physical supports such as inorganic tapes and braids or metal jackets. On exposure to elevated temperatures, compositions in accordance with the present invention may form a physically strong coherent layer around an electrical conductor and therefore do away with the need to use such physical supports.

Certain compositions that exhibit fire-resistance do not also display suitably high electrical resistivity at elevated temperature. When used in cable applications these compositions provide only thermal insulation and/or a physical barrier between the conductor and supporting metal trays or brackets and tend to be electrically conducting in a fire situation leading to circuit failure. In this case additional steps must be taken to ensure electrical insulation is maintained at elevated temperature. For instance, a composition which imparts thermal resistance and/or provides a physical barrier at elevated temperature but which becomes electrically conducting may be provided over a separate layer specifically incorporated in the design to provide electrical insulation. It would be desirable to provide a single composition which confers the required thermal insulation and/or provides the required self-supporting and coherent physical barrier (eg no cracking or fracturing) at elevated temperatures. Furthermore, it is also desirable that this composition functions as an electrical insulator at those temperatures. This is likely to provide significant cost savings and simplify product manufacture.

A further property often required of fire-resistant compositions is that they do not yield any potentially toxic gases or residues when exposed to a fire. Compositions of the present invention may also be inherently safe in this respect.

### SUMMARY OF THE INVENTION

The present invention seeks to provide fire-resistant compositions which exhibit limited, and preferably no, shrinkage when exposed to the kind of elevated temperatures associated with a fire. Furthermore, at such temperatures the compositions may also yield residue which is self-supporting (ie they remain rigid and do not undergo heat induced deformation or flow) and coherent and has good mechanical strength, even after cooling. The residue is retained in its intended position rather than fracturing and being displaced, for example, by mechanical shock. In this context the term ‘residue’ is hereinafter intended to describe the product formed when the composition is exposed to an elevated temperature, experienced under fire conditions. These conditions are simulated in this invention by slowly heating the fire resistant compositions to 1000° C. and maintaining them at this temperature for 30 minutes. Desirably, as well as providing thermal insulation and/or a coherent physical barrier or coating, compositions in accordance with the present invention may also exhibit the required electrical insulating properties at elevated temperatures.

Compositions in accordance with the present invention may also have excellent processability enabling them to be manufactured and used with ease by conventional techniques. In addition the invention allows the preparation of fire resistant polymer products with a wide range of mechanical properties so that the invention can be tailored to suit the requirements of many different applications.

In general terms, the present invention provides a fire resistant composition which comprises inorganic components dispersed in a polymer base composition comprising an organic polymer. The composition is converted into a solid ceramic material after exposure to elevated temperature. In this context a ceramic is an inorganic non-metallic solid material prepared by high temperature processing (e.g. above about 400° C.). The invention seeks to provide fire resistant compositions which undergo limited or no substantial change in dimension and are self-supporting when exposed to fire and which are capable of providing a residual coating that has coherence and adequate physical properties. Such compositions would have widespread application in providing fire resistance to structures and components thereof. The compositions are particularly useful for providing fire resistant insulation for electrical cables as they may provide suitably high electrical resistivity and breakdown strength, even after prolonged heating at high temperature. They can also provide circuit integrity when subsequently subjected to water spray. Use of a polymer base composition comprising an organic polymer affords the potential for cost savings, enhanced processability and improved mechanical properties when compared with systems where the polymer base composition is a silicone polymer.

Accordingly, in one aspect, the present invention provides a fire resistant composition for forming a fire resistant ceramic at elevated temperatures, the composition comprising:
at least 15% by weight based on the total weight of the composition of a polymer base composition comprising at least 50% by weight of an organic polymer;
at least 15% by weight based on the total weight of the composition of a silicate mineral filler; and
at least one source of fluxing oxide which is optionally present in said silicate mineral filler,
wherein after exposure to an elevated temperature experienced under fire conditions, a fluxing oxide is present in an amount of from 1 to 15% by weight of the residue.

The fluxing oxide may be derived from the silicate mineral filler and/or one or more added fluxing oxide or fluxing oxide precursor.

In another aspect of the invention, there is provided a fire resistant cable formed from the fire resistant composition. According to this aspect, there is provided a fire resistant cable comprising a conductive element and at least one insulating layer and/or sheathing for providing a fire resistant ceramic under fire conditions, the insulating layer and/or sheathing layer comprising:
at least 15% by weight based on the total weight of the composition of a polymer base composition comprising at least 50% by weight of an organic polymer;
at least 15% by weight based on the total weight of the composition of a silicate mineral filler; and
at least one source of fluxing oxide which is optionally present in said silicate mineral filler,
wherein after exposure to an elevated temperature experienced under fire conditions, a fluxing oxide is present in an amount from 1 to 15% by weight of the residue.

The fluxing oxide may be derived from the silicate mineral filler and/or one or more separately added fluxing oxide or fluxing oxide precursors.

It has been found that compositions in accordance with the present invention may form a coherent ceramic product when exposed to elevated temperatures and that this product exhibits desirable physical and mechanical properties. The ceramic char formed after exposure of compositions of the present invention at an elevated temperature not in excess of 1050° C. preferably has a flexural strength of at least 0.3 MPa. It is a distinct advantage that the compositions are self supporting, i.e. they remain rigid and do not undergo heat induced deformation or flow. They also undergo little if any shrinkage following high temperature exposure, whether the heating rate experienced is relatively fast or slow. Typically rectangular test specimens exposed to the prescribed slow firing conditions used in this invention will undergo changes in linear dimension along the length of the specimen of less than 10%, preferably less than 5% and most preferably less than 1%. Changes in dimension are also influenced by additional factors including the thermal degradation behaviour of the polymeric component, and can vary from shrinkage to expansion (caused by gases escaping from decomposing components of the composition), with expansion having the most pronounced effect (in a percentage change basis) in the least constrained dimension such as the thickness (height) of a rectangular sheet shape specimen. Thus one skilled in the art can select the components of the composition to achieve a range of outcomes under the expected heating conditions, for example: no significant change in linear dimension, net shape retention, an increase in linear dimension of under 5%, etc.

It is a further advantage, of the compositions of the present invention, that this type of coherent product with desirable physical and mechanical properties can be formed at temperatures well below 1000° C. The compositions of the invention may be used in a variety of applications where it is desired to impart fire resistance to a structure or component. The compositions are therefore useful in passive fire protection systems.

In a preferred form of the invention after firing, the fluxing oxide is present in an amount of 2-10% by weight of the residue and the weight of the residue is at least 40% of the weight of the fire resistant composition. Hence firing results in a weight reduction of less than 60%.

The applicants have found that compositions having fluxing oxide levels in the residue of greater than 15% by weight, experience sustained changes in linear dimension caused by shrinkage when subjected to elevated temperatures which can be experienced under fire conditions. For fire protection applications, it is preferable that this change in linear dimension is less than 10% and more preferably less than 5%, and most preferably less than 1%. Hence, the amount of fluxing oxide in the residue is adjusted to ensure that the composition or articles formed from the composition comply with the desired linear dimension change limits for a given application at the fire rating temperature. As mentioned earlier, the standards for fire rating of cables vary depending on the country, but are generally based on heating the cables to temperatures such as 650°, 750°, 950°, 1050° in a prescribed manner for a specified time such as 15 minutes, 30 minutes, 60 minutes and 2 hours.

As the composition is required to form a self-supporting porous ceramic (typically having porosity of between 20 vol % to 80 vol %) when exposed to fire rating temperatures, it is essential that the composition does not fuse. In the context of this invention, fuse means that the liquid phase produced in the composition becomes a continuous phase, and/or that the reacting mineral silicate fillers particles (eg mica) largely lose their original morphology, and/or that the amount of liquid phase produced becomes sufficient to cause the ceramic to deform due to its own weight. The upper limit for the fluxing oxide content of the residue is 15% by weight to avoid fusing of the composition occurring below the upper temperature of the exposure. Thus in the resulting ceramic the reacting mineral silicate particles (eg mica particles) essentially retain their morphology, with only minor changes at the edges as a result of ‘bridging’ to other particles.

The composition of the present invention includes as an essential component an organic polymer. An organic polymer is one which has an organic polymer as the main chain of the polymer. For example, silicone polymers are not considered to be organic polymers; however, they may be usefully blended with the organic polymer(s), as the minor component, and beneficially provide a source of silicon dioxide (which assists in formation of the ceramic) with a fine particle size when they are thermally decomposed. The organic polymer can be of any type, for example a thermoplastic polymer, a thermoplastic elastomer, a crosslinked elastomer or rubber, a thermoset polymer. The organic polymer may be present in the form of a precursor composition including reagents, prepolymers and/or oligonomers which can be reacted together to form at least one organic polymer of the types mentioned above.

The organic polymer component can comprise a mixture or blend of two or more different organic polymers.

Preferably, the organic polymer can accommodate high levels of inorganic additives, such as the silicate mineral filler, whilst retaining good processing and mechanical properties. It is desirable in accordance with the present invention to include in the fire resistant compositions high levels of inorganic filler as such compositions tend to suffer reduced weight loss on exposure to fire when compared with compositions having lower filler content. Compositions loaded with relatively high concentrations of silicate mineral filler are therefore less likely to shrink and crack when ceramified by the action of heat. The presence in the compositions of the invention of the specified range of fluxing oxide is also believed to contribute in this respect.

It is also advantageous for the chosen organic polymer not to flow or melt prior to its decomposition when exposed to the elevated temperatures encountered in a fire situation. The most preferred polymers include ones that are cross-linked after the fire resistant composition has been formed, or ones that are thermoplastic but have high melting points and/or decompose to form a char near their melting points; however, polymers that do not have these properties may also be used. Suitable organic polymers are commercially available or may be made by the application or adaptation of known techniques. Examples of suitable organic polymers that may be used are given below but it will be appreciated that the selection of a particular organic polymer will also be impacted by such things as the additional components to be included in the fire resistant composition, the way in which the composition is to be prepared and applied, and the intended use of the composition.

As indicated, organic polymers that are suitable for use with this invention include thermoplastic polymers, thermoset polymers, and (thermoplastic) elastomers. Such polymers may comprise homopolymers and copolymers of polyolefins, vinyl polymers, acrylic and methacrylic polymers, styrene polymers, polyamides, polyimides, epoxides, polyoxymethylene acetals, polycarbonates, polyurethanes, polyesters, phenolic resins and melamine-formaldehyde resins.

By way of illustration, examples of thermoplastic polymers suitable for use include polyolefins, polyacrylates, polycarbonates, polyamides (including nylons), polyesters, polystyrenes, polyurethanes and vinyl polymers. Suitable vinyl polymers include poly(vinyl chloride) (PVC) and poly(vinyl acetate) (PVAc).

Suitable polyolefins include homopolymers or copolymers, of alkylenes. Specific examples of suitable polyalkylenes include polymers of the following olefins: ethylene, propylene, butene-1, isobutylene, hexene-1,4-methylpentene, pentene-1, octene-1, nonene-1 and decene-1. These polyolefins may be prepared using peroxide, organometallic complexing catalysts, Ziegler-Natta or metallocene catalysts, as is well known in the art. Copolymers of two or more of these olefins may also be employed, for example, ethylene-propylene copolymers and terpolymers (eg. EPDM), ethylene-butene-1 copolymers, ethylene-hexene-1 copolymers, ethylene-octene-1 copolymers and other copolymers of ethylene with one or more of the above-mentioned olefins. The olefins may also be copolymerised with other monomer species such as vinyl, acrylic or diene compounds. Specific examples of suitable ethylene-based copolymers include ethylene-vinyl acetate (EVA), ethylene-alkyl acrylate, preferably ethylene-ethyl acrylate (EEA) or ethylene-butyl acrylate (EBA), and ethylene-fluoroolefinic monomers, for example, ethylene-tetrafluoroethylene (ETFE).

The thermoplastic polyolefin may also be a blend of two or more of the above-mentioned homopolymers or copolymers. For example, the blend can be a uniform mixture of one of the above systems with one or more of polypropylene, polybutene-1 and polar monomer-containing olefin copolymers. Preferably, the polar-monomer containing olefin copolymers comprises ethylene with one or more of acrylic or vinyl monomers, such as ethylene-acrylic acid copolymers, ethylene-alkyl acrylate copolymers, preferably, ethylene-methyl acrylate, ethylene-ethyl acrylate or ethylene-butyl acrylate copolymers, ethylene-vinyl copolymers, preferably ethylene-vinyl acetate and ethylene-acrylic acid/ethyl acrylate and ethylene-acrylic acid-vinyl acetate terpolymers.

Suitable elastomers may comprise a variety of rubber compositions, such as natural rubber (NR), butyl rubber (IIR), styrene-butadiene rubber (SBR), nitrile-butadiene rubber (NBR), ethylene-propylene rubber (EPM), ethylene-propylene terpolymer rubber (EPDM), epichlorohydrin rubber (ECH) polychloroprene (CR), chlorosulfonated polyethylene (CSM) and chlorinate polyethylene (CM). Suitable thermoplastic elastomers may include styrene-isoprene-styrene (SIS), styrene-butadiene-styrene (SBS) and styrene-ethylene-butadiene-styrene (SEBS).

Suitable thermoset polymers may comprise phenolic resins, melamine-formaldehyde resins, urethane resins, acrylic resins, epoxy resins, polyester resins and vinyl ester resins. Thermoset resins may be produced by any method as is well known in the art.

The organic polymers may be fabricated in the composition by any number of means, including but not limited to in situ polymerisation of monomers, prepolymers or reactive starting compounds and crosslinking or curing of suitable reactive intermediates. Specific examples of suitable monomers, prepolymers and reactive compounds include acrylates, urethanes, epoxides, vinyl esters, phenol, formaldehyde, anhydrides and amines. Curing additives may also be added to assist in generation of the thermoset polymer.

The organic polymer may also be dissolved in a suitable solvent or be in a dispersed form in water or prepared as an emulsion or dispersion in water in order to generate suitable compositions. The emulsion may also be a water-in-oil type. There is wide range of organic polymers and copolymers that can be obtained commercially as water-based dispersions or emulsions that can be used in this invention, for example: acrylics, polyurethanes, EVAs, vinyl esters polymers including poly(vinyl acetate), SBRs.

Coatings and sealants based on organic polymers may be prepared by a number of means, including the use of solvents, emulsions or dispersions. For example, the composition of the present invention may be dissolved or dispersed in water or a suitable solvent, then applied. After application, the mixture may be dried and any solvent evaporated. Where the polymer is a thermoset polymer, the drying step may assist in curing of the reactive intermediates together with any curing additives to form the required coating or sealant.

The organic polymers that are particularly well suited for use in making coatings for cables are commercially available thermoplastic and crosslinked olefin based polymers, co- and terpolymers of any density. Co monomers of interest will be well known to those skilled in the art. Of particular interest are commercially available thermoplastic and crosslinked polyethylenes with densities from 890 to 960 kg/litre, copolymers of ethylenes of this class with acrylic, vinyl and other olefin monomers, terpolymers of ethylene, propylene and diene monomers, so-called thermoplastic vulcanisates where one component is crosslinked while the continuous phase is thermoplastic and variants of this where all of the polymers are either thermoplastic or crosslinked by either peroxide, radiation or so-called silane processes.

Compositions of the invention may be formed about a conducting element or plurality of elements by extrusion (including co-extrusion with other components) or by application of one or more coatings.

As noted, the organic polymer chosen will in part depend upon the intended use of the composition. For instance, in certain applications a degree of flexibility is required of the composition (such as in electrical cable coatings) and the organic polymer will need to be chosen accordingly based on its properties when loaded with additives. Also in selecting the organic polymer account should be taken of any noxious or toxic gases which may be produced on decomposition of the polymer. The generation of such gases may be more tolerable in certain applications than others. Preferably, the organic polymer used is halogen-free.

The polymer base composition can also include at least one other polymer which is not an organic polymer.

Thus, compositions of the present invention may also include a silicone polymer in combination with the organic polymer as the polymer base composition in which the additional components are dispersed.

When used, the nature of the silicone polymer is not especially critical and one skilled in the art will be aware as to the type of polymers which may be used, although account should be had for the various issues described above in connection with the organic polymer (compatibility etc.). Useful silicone polymers are described in detail in the prior art including U.S. Pat. No. 4,184,995, U.S. Pat. No. 4,269,753, U.S. Pat. No. 4,269,757 and U.S. Pat. No. 6,387,518. By way of more specific illustration, the silicone polymer may be an organopolysiloxane composed of units of formula:

$${R}_{r} {\text{SiO}}_{\frac{4 - r}{2}}$$

in which

R may be identical or different and are unsubstituted or substituted hydrocarbon radicals, r is 1, 2, 3 or 4 and has an average numerical value of from 1.9 to 2.1.

Examples of hydrocarbon radicals R are alkyl radicals, such as the methyl, ethyl, n-propyl, isopropyl, n-butyl, isobutyl, tert-butyl, n-pentyl, isopentyl, neopentyl, tert-pentyl and hexyl radicals, such as n-hexyl, heptyl radicals, such as the n-heptyl, octyl radicals, such as the n-octyl, and isooctyl radicals, such as the 2,2,4-trimethylpentyl, nonyl radicals, such as the n-nonyl, decyl radicals, such as the n-decyl, dodecyl radicals, such as the n-dodecyl, octadecyl radicals, such as the n-octadecyl; cycloalkyl radicals, such as cyclopentyl, cyclohexyl and cycolheptyl and methyl cyclohexyl radicals; aryl radicals, such as the phenyl, biphenyl, napthyl and anthryl and phenanthryl; alkaryl radicals, such as o-, m- or p-tolyl radicals, xylyl and ethylphenyl radicals; and aralkyl radicals, such as benzyl and α- and β-phenylethyl.

Examples of substituted hydrocarbon radicals R are halogenated alkyl radicals, such as 3-chloropropyl, the 3,3,3-trifluoropropyl and the perfluorohexylethyl and halogenated aryl, such as the p-chlorophenyl and the p-chlorobenzyl.

The radicals R are preferably hydrogen atoms or hydrocarbon radicals having from 1 to 8 carbon atoms, preferably methyl. Other examples of radicals R are vinyl, allyl, methallyl, 1-propenyl, 1-butenyl and 1-pentenyl, and 5-hexenyl, butadienyl, hexadienyl, cyclopentenyl, cyclopentadienyl, cyclohexenyl, ethynyl, propargyl and 1-propynyl. The radicals R are preferably alkenyl radicals having from 2 to 8 carbon atoms, particularly vinyl.

The end groups of the polymers may be trialkylsiloxy groups, for example trimethylsiloxy or dimethylvinylsiloxy groups, or derived groups where one or more of the alkyl groups has been replaced by hydroxy or alkoxy groups.

The silicone polymer may be crosslinkable. The crosslinkable polymer can be any one which can be crosslinked by any one of the methods used for commercially available organopolysiloxane polymers including by free radical crosslinking with a peroxide through the formation of ethylenic bridges between chains, by addition reactions including reaction of silylhydride groups with allyl or vinyl groups attached to silicon, through condensation reactions including the reactions of silanols to yield Si—O—Si crosslinks, or using other reactive groups. Depending on the type of silicone polymer used the composition will therefore further comprise a suitable crosslinking agent. Suitable crosslinking agents are commercially available, for example there is a wide range of useful peroxides suitable for use in this application, such as dibenzoyl peroxide, bis (2,4-dichlorobenzoyl) peroxide, dicumyl peroxide or 2,5-bis(tert-butylporoxy)-2,5-dimethylhexene or also mixtures of these, and when appropriate they may be included in the composition during the compounding process.

A silicone polymer type especially suitable for cable insulation is where the silicone polymer is of high molecular weight and has vinyl side chains that require heat to crosslink, either through platinum catalysed addition reactions or peroxide initiated free radical reactions. These silicone polymers are widely available commercially from major silicone producers.

The organopolysiloxane materials may also comprise reinforcing fillers such as precipitated or pyrogenic silicas and/or non-reinforcing fillers. Further, the surface of these silica type fillers may be modified by straight or branched organopolysiloxanes, organo-chlorosilanes and/or hexamethyl disilazanes.

The organic polymer is present in the polymer base composition in an amount of at least 50% by weight. This facilitates loading of the polymer base composition with the additional components without detriment to the processability of the overall composition. As noted the polymer base composition may include a silicone polymer. However, in this case the organic polymer would usually be present in the polymer base composition in a significant excess when compared with the silicone polymer. Thus, in the polymer base composition the weight ratio of organic polymer to silicone polymer may be from 5:1 to 2:1, for instance from 4:1 to 3:1. In terms of weight percentage, if present, the silicone polymer might generally be present in an amount of from 2 to 15% by weight based on the total weight of the formulated fire resistant composition. When a combination of organic and silicone polymers are used, high concentrations of silicone polymer can present processing problems and this should be taken into account when formulating compositions in accordance with the present invention.

The upper limit for the amount of polymer base composition in the fire resistant composition tends to be influenced by the desired properties of the formulated composition. If the amount of the polymer base composition exceeds about 60% by weight of the overall composition, it is unlikely that a cohesive, strong residue will be formed during a fire situation. Thus, the polymer base composition generally forms from 10 to 60%, preferably from 20 to 50%, by weight of the formulated fire resistant composition.

The compositions in accordance with the present invention also include a silicate mineral filler as an essential component. Such fillers typically include alumino-silicates (e.g. kaolinite, montmorillonite, pyrophillite—commonly known as clays), alkali alumino-silicates (e.g. mica, felspar, spodumene, petalite), magnesium silicates (e.g. talc) and calcium silicates (e.g. wollastonite). Mixtures of two or more different silicate mineral fillers may be used. Such fillers are commercially available. Silicon dioxide (silica) is not a silicate mineral filler in the context of the present invention.

The silicate mineral filler may be surface treated with a silane coupling agent in order to enhance its compatibility with other materials present in the compositions of the present invention.

The compositions of the invention include at least 15% by weight, preferably at least 25% by weight and more preferably at least 55% by weight, silicate mineral filler. The maximum amount of this component tends to be dictated by the processability of the composition. Very high levels of filler can make formation of a blended composition difficult. Usually, the maximum amount of silicate mineral filler would be about 80% by weight. The amount and type of silicate mineral filler used will also be dictated by the requirement to have a certain range of fluxing oxide in the residue formed by heating the composition at elevated temperatures experienced under fire conditions. As will be explained, the fluxing oxide can be generated in situ at elevated temperature by heating certain types of silicate mineral fillers (eg mica), to make the fluxing oxide become available at the surfaces of the filler particles. Additionally, or alternatively the fluxing oxide may come from a source other than the silicate mineral filler. As is explained later, the fluxing oxide is believed to act as an “adhesive” assisting in formation of a coherent product at high temperature. The fluxing oxide is believed to contribute a binding flux at the edges of the filler particles. The presence of a high proportion of silicate mineral filler results in a composition which is likely to exhibit low shrinkage and cracking when a ceramic is formed at elevated temperature, and on cooling of the ceramic.

The compositions of the present invention also include a fluxing oxide as an essential component. By this it is meant an oxide that melts by itself below 1000° C. or reacts with a silicate or other inorganic component to melt at temperatures below about 1000° C. The generation of such a liquid phase, as well as the amount generated, play an important role in yielding a ceramic structure having a desirable combination of properties following exposure at elevated temperature. As noted, the fluxing oxide may be generated by heating certain silicate mineral particles (eg mica) to make the fluxing oxide become available at the surface of the particles. Alternatively, or additionally, a fluxing oxide or precursor thereof may be added to the composition.

Without wishing to be bound by theory, it is believed that compositions in accordance with the present invention form a coherent ceramic product after exposure to elevated temperatures as a result of a fluxing oxide locally forming a eutectic composition at the interface of the silicate mineral filler particles and/or of other inorganic particles present in the composition or formed from decomposition thereof. These inorganic particles include other silicates minerals, and possibly silicon dioxide (either derived from heating the silicate mineral filler, added as an additional filler and/or generated by thermal decomposition of a silicone polymer or any silicone additive). When the fluxing oxide is added as a separate component to the composition, a eutectic forms at the interface between the fluxing oxide and the contacting reactive particles. Ordinarily the silicate mineral filler, and any additional inorganic components, each have very high melting points. However, the presence of the fluxing oxide may result in eutectics at the interfaces of these causing melting at lower temperatures. The fluxing oxide causes formation of a eutectic which may act as a “bridge” between the particles of silicate mineral filler and other inorganic components present. This is thought to assist in “binding” the decomposition products of the composition, silicate mineral filler, and, when present, other components. In this way formation of a coherent ceramic product is improved and it is possible to reduce the temperature required to form a comparatively strong porous ceramic material. It is very important to control the extent of eutectic formation and melting in the composition to control shrinkage and the creation of molten conductive pathways in the heated material. Compositions in accordance with the present invention may yield a coherent porous ceramic product that is self-supporting and undergoes limited, and preferably no, shrinkage following exposure to elevated temperature in a fire.

In general the fluxing oxide additive may be any compound which is capable of functioning in the manner described in order to form a ceramic product having the desired combination of properties. In practice, however, the fluxing oxide is likely to be boron oxide or a metal oxide selected from the oxides of lithium, potassium, sodium, phosphorus, and vanadium. As mentioned, the fluxing oxide may be generated by heating certain silicate mineral fillers (eg mica), it can be separately added or it is also possible to include in compositions of the present invention, a precursor of the fluxing oxide (eg a metal hydroxide or metal carbonate precursors to the metal oxides), that is a compound that yields the fluxing oxide following exposure at the kind of elevated temperatures likely to be encountered in a fire. In that case the fluxing oxide is likely to be formed by thermal decomposition of the precursor. Similarly, when boric oxide is used as the fluxing oxide, it may be derived from a suitable precursor compound. Borates, and particularly zinc borate, provide useful precursors for boric oxide.

While lead oxide and antimony oxide can be used as fluxing oxides, usually the compositions of this invention are free from lead and antimony as they may constitute health and safety problems due to their toxicity.

The fluxing oxide precursor may be a glass and a variety of glasses may be used. It should be noted however that to remain electrically insulating a low alkali metal content in the flux is desirable. The glass may take a variety of forms such as powder or fibres. Mixtures of one or more of these may be used. The preferred form is glass powder or frit. Irrespective of form, the glass additive preferably has a softening point below 1000° C., for example, below 800° C., and most preferably between 300 and 800° C. The softening point of the glass is defined by the temperature at which the viscosity of the glass equal 10^{7.6} poise. The glass additive may be one or a combination of silicate, borate and/or phosphate glass systems. Suitable glass additives are commercially available.

As described, it is quite possible that one or more silicate mineral filler will contribute fluxing oxide following exposure at elevated temperature. In one embodiment, all of the fluxing oxides are derived from the silicate mineral filler(s). In another embodiment, the fluxing oxide is derived from the silicate mineral filler and another source, and this may lead to advantages in terms of the structure formed at elevated temperature due to fluxing oxide being provided from within particles of the silicate mineral filler and external to such particles. In a further embodiment the fluxing oxide is derived from the silicate mineral filler and an added boric oxide or a source of boric oxide (e.g. zinc borate). In a further embodiment the fluxing oxide is derived from the silicate mineral and added glass. In yet another embodiment fluxing oxide is derived from the silicate mineral added glass and boric oxide or a source of boric oxide. In a yet further embodiment the fluxing oxide is derived from a source or sources other than the silicate mineral filler.

In one embodiment the composition includes at least two different fluxing oxides which form liquid phases at different temperatures. This can enhance char integrity as well as ensuring that the composition functions as required over a broad temperature range.

The compositions should be formulated so that the residue formed contains 1-15%, and preferably 1-10%, more preferably 2-8% of a fluxing oxide regardless of the source of this oxide. In other words 15% by weight is the maximum amount of fluxing oxide that should be present in the residue. When the fluxing oxide is derived from the silicate mineral filler or precursor such as zinc borate or other additive, the amount of fluxing oxide may be calculated on the basis of the maximum amount of fluxing oxide this component would yield at elevated temperature. This calculation will, for instance, be based on the total amount of elements such as boron, phosphorus, lithium, sodium, potassium and vanadium which are present in the silicate mineral filler, borate and other additives and which can in theory result in formation of the corresponding fluxing oxides. To minimise shrinkage, it is preferred that the amount of fluxing oxide is as low as necessary to enable formation of a coherent ceramic product on exposure to the kind of elevated temperature encountered in a fire. It has also been found that the physical form of the filler can influence the extent of shrinkage when the composition is heated. More specifically, it has been found that fillers composed of large platelike particles confer less shrinkage and thus lower percentage changes in linear dimension.

Preferably, the compositions of the present invention include at least one silicate mineral that is an appreciable source of fluxing oxide. Mica satisfies this requirement and provides additional benefits because it is also available in plate form, making it a preferred component. The two most common classes of commercially available mica are muscovite and phlogopite, and these are therefore typically used in the present invention. Muscovite mica is a dioctahedral alkali aluminium silicate. Muscovite has a layered structure of aluminium silicate sheets weakly bonded together by layers of potassium ions. It has the following composition KAl₃Si₃O₁₀(OH)₂. Phlogopite mica is a trioctahedral alkali aluminium silicate. Phlogopite has a layered structure of magnesium aluminium silicate sheets weakly bonded together by layers of potassium ions. It has the following composition KMg₃A1Si₃O₁₀(OH)₂. Both mica types are typically present in the form of thin plates or flakes having sharply defined edges.

The composition of the present invention may contain silicon dioxide as a result of being exposed to elevated temperature. For instance, this silicon dioxide may be derived from heating the silicate mineral filler. It may also come from thermal decomposition of a silicone polymer when included in the polymer base composition. Silica may also be added as a separate filler component.

In addition to the mineral silicate fillers, a wide variety of other inorganic fillers may be added. Preferred inorganic fillers are silicon dioxide and metal oxides of calcium, iron, magnesium, aluminium, zircon, zinc, tin and barium (preferably added as fine powders), or inorganic fillers which generate these oxides when they thermally decomposes (eg the corresponding carbonates and hydroxides), since these oxides can react and/or sinter at less than 1000° C. the other inorganic components to assist in formation of the self supporting ceramic.

Also inorganic fibres which do not melt at 1000° C. can be incorporated, including aluminosilicate fibres. This may lead to a reduction in dimensional changes at elevated temperature and/or improved mechanical properties of the resulting ceramic.

Usually, after exposure at elevated temperature (to 1000° C.) the residue remaining will generally constitute at least 40%, preferably at least 55% and more preferably at least 70%, by weight of the composition before pyrolysis. Higher amounts of residue are preferred as this may improve the char (ceramic) strength at all temperatures by better mechanical interlocking of particles and also a reduced tendency to shrink.

As mentioned, it has also been found that the mechanical properties of the ceramic formed from the composition of the present invention can be enhanced by including in the composition a low level of boric oxide or precursor thereof which yields boric oxide at elevated temperature e.g. zinc borate. In this case however the total amount of boric oxide and other fluxing oxides will not exceed 15% by weight of the residue obtained after heating the composition for 30 minutes at 1000° C.

It has also been found that removing volatile decomposition products from fillers such as clay by calcining prior to addition to the composition reduces shrinkage when the composition of the invention is heated at an elevated temperature. This is believed to help reduce mass change and linear dimensional change of the composition when exposed to elevated temperature.

As explained, preferably the compositions exhibit minimal linear dimensional change after exposure to the kind of temperatures likely to be encountered in a fire. By this is meant that the maximum linear dimensional change in a product formed from a composition in accordance with the present invention is less than 10%, preferably less than 5% and most preferably less than 1%. In some cases net shape retention is the most preferred property.

Compositions in accordance with the invention may also exhibit the electrical insulating properties at high temperature that are required for use in electric cables. Essentially this means that the electrical resistance of the material, while less than at room temperature, does not fall to a point where the normal operating voltage can overcome the insulation resistance of the material and cause a short circuit.

The compositions of the invention are also preferably free of other elements that may constitute a health and safety problem due to toxicity. Thus, the compositions are preferably free of halogen compounds.

For cable applications, where the electrical resistivity of the composition is important, the levels of alkali ions present must be carefully considered as they can cause electrical conductivity at high temperatures. For example in a given composition, if the level of mica is too high electrical integrity problems arise due to an unacceptable reduction in electrical resistivity of the composition and/or from dielectric breakdown when the compositions are subjected to high temperatures for an extended period of time. At high temperatures alkali metal ions, for instance from mica, tend to provide conductive pathways, resulting in the need to limit the level of mica.

In a preferred form, the composition comprises a fire resistant composition according to claim 1, wherein:
20 to 75% by weight of said polymer base composition wherein said composition further comprises a silicone polymer;
at least 15% by weight of an inorganic filler wherein said inorganic filler comprises mica and a glass additive; and
wherein the fluxing oxide in the residue is derived from glass and mica wherein, the ratio of mica:glass is in the range of from 20:1 to 2:1. The organic filler may comprise 10 to 30% by weight of the total composition of mica and 20 to 40% by weight of the total composition of an additional inorganic filler.

In one embodiment of the present invention it has been found that having a relatively high concentration of fluxing oxides in the composition of the invention can lead to formation of a glassy surface layer when the composition is ceramified (at elevated temperature) and cooled. Desirably, this surface layer has been found to confer improved water resistance to the ceramic formed. The surface layer can also make the resulting ceramic a more effective barrier to the passage of gases and smoke. The formation of such a surface layer, and associated enhanced water resistance, is particularly beneficial in electrical cable applications because ingress of water (used to quench a fire) through the ceramic is likely to lead to electrical shorting. Of course, the potentially detrimental effects of high levels of a glass phase (shrinkage and electrical conductivity) must be taken into account. The amount of fluxing oxide required to form the glassy surface layer when the composition forms a ceramic may vary depending upon the layer thickness (see below) and other ingredients present in the composition. However, in general terms the fluxing oxide level is desirably more than 5% of the residue obtained after heating the composition for 30 minutes at 1000° C. The total amount of glass phase present in the heated composition may be derived from a single source or from more than one source. For instance, the glass phase may be derived predominantly from glass frits, fibres and/or particles of the same or different type glass. A similar effect may be observed by using a relatively high concentration of mica, for example about 25% by weight, since this too can lead to the formation of sufficient liquid phase during heating.

The mechanism by which the glassy surface layer (skin) is formed is not clearly understood, although glass flow is clearly required in order to form the (densified) glassy surface layer. This means that the melting temperature of the glass additive and/or the liquid phase formed by fluxing oxides from other sources must be selected so that some flow is possible at the ceramic-forming temperature. It may be desirable to incorporate a variety of glass phases with different melting points to achieve skin formation and the desirable mechanical properties. The mechanism for formation of the glassy surface layer may be associated with surface tension effects between the molten glass and its local environment. One possible explanation for migration and aggregation of glass to the surface of the formed ceramic is that the surface energy at the glass/atmosphere interface is lower than that of the energy at the interface between the molten glass and the bulk of the composition. This being so, the molten glass migrates to the lower energy interface.

It has been found that the thickness of the composition may have an impact on the formation of the water resistant surface layer. This is believed to be due to volume effects, with more glass (and/or mica) being available for formation of a suitably thick surface layer when the thickness of the composition is greater. It has been observed in fact that a thicker sample of a composition yields a more water resistant surface layer than a thinner sample of the same composition.

Water resistance can also be improved by the addition of inorganic fibres which do not melt at 1000° C. Alumino-silicate fibres are preferred and can be used at levels of up to 10% by weight.

Other components may be incorporated into the compositions of the present invention. These other components include lubricants, plasticisers, inert fillers (eg fillers that are not the metal oxides that can react and/or sinter with the other inorganic components, or their precursors), antioxidants, fire retardant materials, fibre reinforcing materials, materials that reduce thermal conductivity (eg exfoliated vermiculite), chemical foaming agents (which serve to reduce density, improve thermal characteristics and further enhance noise attenuation), and intumescing materials (to obtain a composition that expands upon exposure to fire or elevated temperature). Suitable intumescing materials include natural graphite, unexpanded vermiculite or unexpanded perlite. Other types of intumescing precursors may also be used. The total amount of such additional components does not usually exceed 20% by weight based on the total weight of the composition.

The composition containing an organic polymer can be prepared in any conceivable way. This includes adding the other components to: a monomer (or mixture of monomers) which is (are) then polymerised; prepolymers and/or oligomers which are then polymerised by chain extension and/or crosslinking reactions; thermoplastic polymers by melt blending; aqueous organic polymer dispersions by dispersive mixing (where the water present is not considered part of the composition in this invention); a solution of a polymer dissolved in a solvent (where the solvent present is not considered part of the composition in this invention); and thermosetting systems which are subsequently crosslinked. Regardless how the composition is prepared it is necessary that added components (mineral fillers, other inorganic components, and other organic additives) can be effectively mixed with the organic polymer(s), or the precursors used to form the polymer(s), so that they are well dispersed in the resulting composition and that the composition can be readily processed to produce the desired end product.

Any conventional compounding equipment may also be used. If the composition has relatively low viscosity, it may be processed using dispersing equipment, for instance of the type used in the paint industry. Materials useful for cable insulation applications are of higher viscosity (higher molecular weight) and may be processed using a two roll mill, internal mixers, twin-screw extruders and the like. Depending upon the type of crosslinking agent/catalyst added, the composition can be cured by exposure to air at 200° C., in an autoclave with high pressure steam, using continuous vulcanisation equipment including a liquid salt bath and, conceivably, by exposure to any medium that will cause the peroxide to decompose, including microwaves, ultrasonics etc.

The compositions of the present invention may be used in a large number of applications where fire resistance is desired. For example, the compositions may be used to form a fire resistant building panel or in the manufacture of glass fibre reinforced polymer composites. The composition may be used by itself or together with one or more layers of other materials.

The compositions of the present invention may be provided in a variety of different forms, including:
1. As a sheet, profile or complex shape. The composition may be fabricated into these products using standard polymer processing operations, eg extrusion, moulding (including hot pressing and injection moulding). The products formed can be used in passive fire protection systems. The composition can be used in its own right, or as a laminate or composite with another material (for example, plywood, vermiculite board or other). In one application the composition may be extruded into shapes to make seals for fire doors. In the event of a fire, the composition is converted into a ceramic thus forming an effective mechanical seal against the spread of fire and smoke.
2. As a pre-expanded sheet or profile. This form has additional benefits compared with the above, including reduced weight and the capacity for greater noise attenuation and insulation during normal operating conditions. Porosity can be incorporated into the material during manufacture of the sheet or profile by thermal degradation of a chemical blowing agent to produce a gas product, or by physically injecting gas into the composition during processing before curing.
3. As an intumescent product, which expands by foaming when exposed to heat or fire. In this application the product can be used, for example, around pipework or penetrations between walls. In the event of a fire the product expands to fill the void and provide an effective plug to prevent the spread of fire. The intumescent material may be in the form of an extrudable paste or a flexible seal.
4. As a mastic material which can be applied (for example from a tube as per a conventional silicone sealant) as a seal for windows and other articles.
5. As a paint, or an aerosol based material, that could be sprayed or applied by with a brush.

Specific examples of passive fire protection applications where this invention may be applied include but are not limited to firewall linings for ferries, trains and other vehicles, fire partitions, screens, ceilings and linings, structural fire protection [to insulate the structural metal frame of a building to allow it to maintain its required load bearing strength (or limit the core temperature) for a fixed period of time], fire door inserts, window and door seals, intumescent seals, and compounds for use in electrical boxes, in fittings, straps, trays etc that are attached to or used to house cables or similar applications.

Another area of application is in general engineering. Specific areas of general engineering, where passive fire protection properties are required, include transportation (automotive, aerospace, shipping), defence and machinery. Components in these applications may be totally or partially subject to fire.

When totally subject to fire, the material will transform to a ceramic barrier, thereby protecting enclosed or separated areas. When partially subjected to fire, it may be desirable for the portion of the material subjected to the fire to transform to ceramic, being held in place by the surrounding material that has not transformed to ceramic. Applications in the transport area may include panelling (eg in glass fibre reinforced thermoplastic or thermoset composites), exhaust, engine, braking, steering, safety devices, air conditioning, fuel storage, housings and many others. Applications in defence would include both mobile and non-mobile weapons, vehicles, equipment, structures and other areas. Applications in the machinery area may include bearings, housing barriers and many others.

### DESCRIPTION OF THE DRAWINGS

FIG. 1 is a perspective view of a cable having an insulating layer in accordance with the invention; and

FIG. 2 is a perspective view of a multiconductor cable in which compositions of the invention are used as a sheath.

The compositions of the present invention are especially useful in the coating of conductors. The compositions are therefore suitable for the manufacture of electrical cables that can provide circuit integrity in the case of fire.

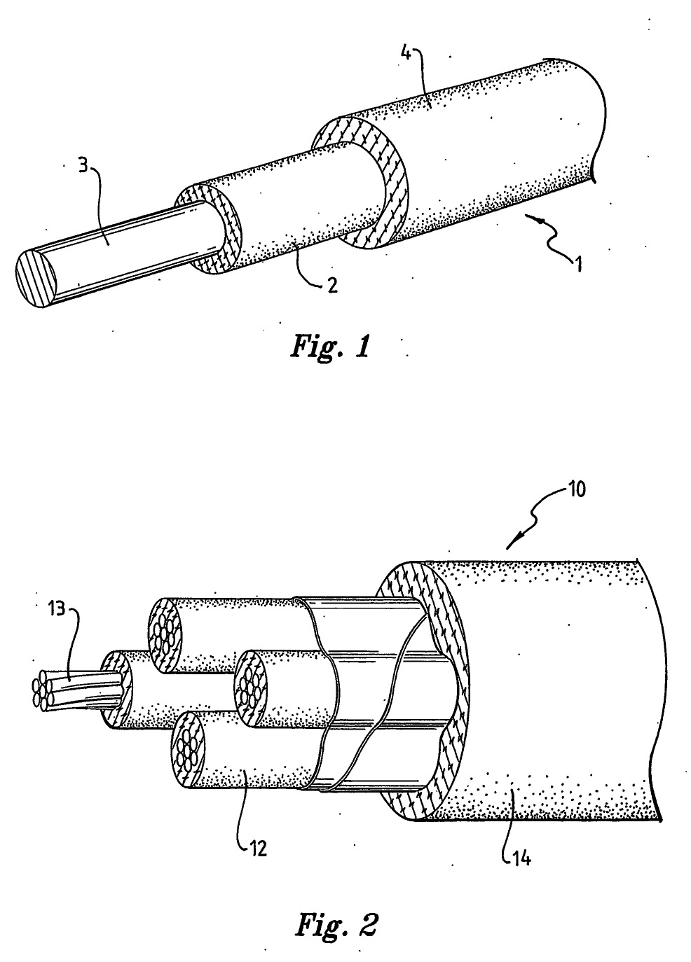

FIGS. 1 and 2 show single and multiconductor cables 1, 10 respectively which have an insulation layer 2, or layers 12 and have a sheathing layer 4, 14. In both of these cable designs, the insulation layer and/or the sheathing layer are formed compositions in accordance with the invention.

In the design of such cables the compositions can be used as an extruded insulation directly over conductors and/or used as an extruded sheathing layer over an insulation layer or layers. Alternatively, they can be used as an interstice filler in multi-core cables, as individual extruded fillers added to an assembly to round off the assembly, as an inner layer prior to the application of wire or tape armour.

In practice the composition will typically be extruded onto the surface of a conductor. This extrusion may be carried out in a conventional manner using conventional equipment. The thickness of the layer of insulation will depend upon the requirements of the particular standard for the size of conductor and operating voltage. Typically the insulation will have a thickness from 0.6 to 3 mm. For example, for a 35 mm² conductor rated at 0.6/1 kV to Australian Standards would require an insulation thickness of approximately 1.2 mm. As noted, compositions in accordance with the invention may exhibit excellent thermal and electrical insulating properties at elevated temperature. When used such compositions enable a cable of elegantly simple design to be manufactured since there is then no need to include a distinct layer to confer electrical insulating properties. According to this aspect the present invention provides electrical cables consisting of a suitable composition in accordance with the present invention provided directly on a conductor. The cable may include other layers such as a cut-resistant layer and/or sheathing layer. However, the cable does not require an additional layer intended to maintain electrical insulation at elevated temperature.

### EXAMPLES

The specification and claims refer to terms which are defined below along with test methods for their determination. The tests to determine these properties should ideally be conducted on specimens 30 mm×13 mm×2 mm (approximately), although in some examples specimens with somewhat different dimensions have been used. The properties and conditions are:
Slow firing conditions. Heating test specimens from room temperature to 1000° C. at a temperature increase rate of 12° C./min followed by holding at 1000° C. for 30 minutes. These conditions are those representative of ‘exposure to an elevated temperature experienced under fire conditions.’
Fast firing conditions. Placing test specimens into a pre-heated furnace at 1000° C. and maintaining the furnace at that temperature for 30 minutes.

These conditions are representative of exposures that may be achieved under a scenario of very rapid heating in a fire. In the examples, some of the compositions have been exposed to these firing conditions to illustrate the effect of different firing conditions on some of the measured properties.
Change in linear dimension. The change in linear dimension along the length of the specimen. The method of determining the change in linear dimension is by measuring the length of the specimen before firing and upon cooling after being subjected to slow firing conditions. An expansion of specimen caused by firing is reported as a positive change in linear dimension and a contraction (shrinkage) as a negative change in linear dimension. It is quoted as a percentage change. In the examples, the change in linear dimension has also been determined on samples that have been subjected to fast firing conditions to compare the effects caused by different heating rates.
Flexural strength. The flexural strength of the ceramic is determined by heating the test specimen under slow firing conditions and, upon cooling, carrying out the determination by three-point bending of a span length of 18 mm using a loading cross head speed of 0.2 mm/minute. In the examples, flexural strengths have also been determined on samples that have been subjected to fast firing conditions to compare the effects caused by different heating rates.
Residue. The material remaining after a composition has been subjected to elevated temperatures experienced under fire conditions. In the context of this invention, those conditions are simulated heating the composition from room temperature to 1000° C. at a temperature increase rate of 12° C./min followed by holding at 1000° C. for 30 minutes. Self supporting. Compositions that remain rigid and do not undergo heat induced deformation or flow. Determined by placing a specimen on a rectangular piece of refractory so that the long axis is perpendicular to the edge of the refectory block and a 13 mm portion is projecting out from the edge of the block, then heating under slow firing conditions and examining the cooled specimen. A self supporting composition remains rigid, and is able to support its own weight without bending over the edge of the support. In the examples, the effect of varying the maximum heating temperature is also shown.
Net shape retention. Compositions that undergo no substantial change in shape when heated. This will depend in part on the shape and dimensions of the specimen being tested and the firing conditions used.
A two-roll mill was used to prepare the compositions described in Examples 1, 2, 3, 4, 6, 7, 8 and 9. The ethylene propylene rubber was banded on the mill (10-20° C.) and other components were added and allowed to disperse by separating and recombining the band of material just before it passed through the nip of the two rolls. When these were uniformly dispersed, the peroxide was added and dispersed in a similar manner.

Unless mentioned otherwise in an example, the following conditions were used for specimen preparation:
Flat rectangular sheet specimens of required dimensions were fabricated from the milled compositions containing rubbers/elastomers by curing and moulding at 170° C. for 30 minutes under a pressure of approximately 7 MPa.

The fluxing oxide weight contributed to the residue after 100 g of each of the clay, talc and mica used in the examples was heated at 1000° C. for 30 minutes was 1.0 g, 1.7 g and 11.1 g respectively. The residue content of each was 86.1 g, 96.0 g, and 96.9 g respectively. Unless mentioned otherwise in an example, the average particle size of mica, clay and talc used in the examples was 160 μm, 1.5 μm and less than 10 μm respectively.

### Example 1

A number of compositions (see Table 1) were prepared and are denoted A-T. After firing, each sample took the form of a ceramic char. The change in linear dimension resulting from firing and the flexural strength of the ceramic char formed were determined as described above after cooling the samples to room temperature. All of the samples shown in Table 1 are suitable for use as an insulation layer and/or sheathing layer on a cable.

Composition A is an example of a basic composition that consists of only one organic polymer, silicate mineral fillers, a small amount of a fluxing oxide and some additives.

Sample B is a composition comprising a blend of an organic polymer with a small amount of a silicone polymer which is a source of silica for char formation. This composition does not contain any separately added fluxing oxides (all the fluxes are derived from mineral fillers).

Sample C has a composition that contains a small amount of glass frit as a source of fluxing oxide. Comparison of Samples B and C shows that the addition of a small amount of a glass as a source of fluxing oxide can improve char strength.

Comparison of Samples C and D shows that some silicate mineral fillers, in this case clay, can lead to much higher char shrinkage than other fillers.

Comparison of Samples D and E shows that adding higher amounts of glass frit results in increased shrinkage and char strength.

Comparison of Samples F and G shows that removing volatile decomposition products from fillers such as clay by pre-calcining, reduces the char shrinkage with no significant adverse effect on char strength.

Comparison of Samples G and H shows that more talc and less clay is favourable for reducing the char shrinkage.

Comparison of Samples A and H shows that the effect of boric oxide is independent of the type of source used (zinc borate or boric oxide) provided the quantity of boric oxide is the same. This also shows that zinc oxide introduced by zinc borate has no noticeable role in char shrinkage or strength. Its effect is similar to that of aluminium oxide.

Comparison of Samples J and K shows that higher amounts of boric oxide results in higher amounts of shrinkage.

Sample M contains aluminium hydroxide and silicate mineral fillers with no separately added fluxing oxide.

Sample N is an example of a composition that does not contain any clay or talc, but contains aluminium hydroxide, mica and wollastonite.

Comparison of Samples O and P shows that larger particles of a mineral filler reduce shrinkage.

Comparison of Samples Q, R and S shows that addition of fine silica either as silica powder or as a silicone polymer that decomposes giving silica powder causes an increase in shrinkage and strength of char.

TABLE 1

| Composition | A | B | C | D | E | F | G | H | J | K |
|---|---|---|---|---|---|---|---|---|---|---|
| Ethylene propylene rubber | 22 | 22.4 | 22 | 22 | 22 | 22 | 22 | 22 | 22 | 22 |
| Silicone rubber | | 5.8 | 6 | 6 | 6 | | | | | |
| Clay | 10 | | | 24 | 21 | | 30 | 10 | 10 | 10 |
| Calcined clay | | | | | | 30.0 | | | | |
| Talc | 44 | 31.0 | 28 | 14 | 14 | 23 | 23 | 43 | 52 | 49 |
| Muscovite Mica | 9 | 29.1 | 30 | 20 | 20 | 9 | 9 | 9 | | |
| Zinc Borate | | | | | | 4 | 4 | 4 | 4 | 7 |
| Glass Frit (flux content - 5.1%) | | | 2 | 2 | 5 | | | | | |
| Fine silica | | | | | | | | | | |
| Boric Oxide | 1.35 | | | | | | | | | |
| Alumina | 1.65 | | | | | | | | | |
| Coarse Wollastonite | | | | | | | | | | |
| Fine Wollastonite | | | | | | | | | | |
| Aluminium tri-hydrate | | | | | | | | | | |
| Peroxide | 3 | 2.3 | 3 | 3 | 3 | 3 | 3 | 3 | 3 | 3 |
| Other additives (lubricants, plasticisers, | 9 | 9.4 | 9 | 9 | 9 | 9 | 9 | 9 | 9 | 9 |
| antioxidents etc) | | | | | | | | | | |
| Total | 100 | 100 | 100 | 100 | 100 | 100 | 100 | 100 | 100 | 100 |
| Firing Condition | Slow | Slow | Slow | Fast | Fast | Fast | Fast | Slow | Slow | Slow |
| Linear dimension change - % | 3.8 | 0.5 | 1.2 | 6.1 | 8.8 | 5.4 | 7.0 | 3.4 | 3.3 | 6.3 |
| Flexural strength of char - MPa | 8.2 | 1.1 | 2.6 | 3.1 | 9.4 | 5.2 | 5.3 | 7.4 | 7.4 | 7.6 |
| Total Flux - % | 3.2 | 3.8 | 3.9 | 2.8 | 2.9 | 3.2 | 3.1 | 3.3 | 2.4 | 3.5 |
| Total silicate mineral fillers - % | 63.0 | 60.1 | 58.0 | 58.0 | 55.0 | 62.0 | 62.0 | 62.0 | 62.0 | 59.0 |
| Residue content after burning at 1000° C. - % | 62.5 | 60.8 | 60.8 | 58.4 | 58.8 | 64.0 | 59.9 | 61.8 | 61.7 | 61.3 |
| Flux content as a % at residue content | 5.1 | 6.2 | 6.43 | 4.8 | 4.98 | 4.98 | 5.25 | 5.31 | 3.96 | 5.67 |

| Composition | L | M | N | O | P | Q | R | S | T |
|---|---|---|---|---|---|---|---|---|---|
| Ethylene propylene rubber | 22 | 20 | 22 | 22 | 22 | 22 | 22 | 23.4 | 22 |
| Silicone rubber | | 4.8 | 6 | 6 | 6 | 1 | 5 | | 6 |
| Clay | | 19.2 | | 14 | 14 | 24 | 24 | 25.5 | 24 |
| Calcined clay | | | | | | | | | |
| Talc | 64 | 12 | | 14 | 14 | 14 | 14 | 14.9 | 14 |
| Muscovite Mica | | 16 | 20 | 20 | 20 | 20 | 20 | 21.3 | 20 |
| Zinc Borate | 2 | | | | | | | | |
| Glass Frit (flux content - 5.1%) | | | 2 | 2 | 2 | 2 | 2 | 2.1 | 2 |
| Fine silica | | | | | | 5 | 1 | | |
| Boric Oxide | | | | | | | | | |
| Alumina | | | | | | | | | |
| Coarse Wollastonite | | | | 10 | | | | | |
| Fine Wollastonite | | | 18 | | 10 | | | | |
| Aluminium tri-hydrate | | 20 | 20 | | | | | | |
| Peroxide | 3 | 2.4 | 3 | 3 | 3 | 3 | 3 | 3.2 | 3 |
| Other additives (lubricants, plasticisers, | 9 | 5.6 | 9 | 9 | 9 | 9 | 9 | 9.6 | 9 |
| antioxidents etc) | | | | | | | | | |
| Total | 100 | 100 | 100 | 100 | 100 | 100 | 100 | 100 | 100 |
| Firing Condition | Slow | Fast | Fast | Slow | Slow | Fast | Fast | Fast | Fast |
| Linear dimension change - % | 2.0 | 3.1 | 0.0 | 3.9 | 4.8 | 6.0 | 5.7 | 3.2 | 6.8 |
| Flexural strength of char - MPa | 1.6 | 1.0 | 1.4 | 1.3 | 2.7 | 2.3 | 3.6 | 1.6 | 3.9 |
| Total Flux - % | 1.8 | 2.2 | 2.5 | 2.8 | 2.8 | 2.8 | 2.8 | 3.0 | 2.8 |
| Total silicate mineral fillers - % | 64.0 | 47.2 | 38.0 | 58.0 | 58.0 | 58.0 | 58.0 | 61.7 | 58.0 |
| Residue content after burning at 1000° C. - % | 63.0 | 58.9 | 55.3 | 59.7 | 59.7 | 61.0 | 58.9 | 59.0 | 58.4 |
| Flux content as a % at residue content | 2.91 | 3.7 | 4.46 | 4.66 | 4.66 | 4.6 | 4.76 | 5.1 | 4.8 |

### Example 2

Electric cables were made using compositions B and T from the table above. Those made with composition T exhibited a high char shrinkage that resulted in cracking of the insulation layer at 1050° C., leading to insulation failure in the fire test (heating stage) according to AS/NZS 3013:1995. Cables made with the composition B that has a low char shrinkage passed the same test. The char produced was free of large visible cracks in the case of composition B whereas the char formed from composition T was heavily cracked leaving the conductor exposed.

### Example 3

A composition (X) having the constituents listed in Table 2 below was prepared. Composition X was based on a commercially available ethylene propylene elastomer and silicone elastomer. The mica used was muscovite with a mean particle size of 160 μm determined by sieve analysis. Glass frit A has a softening point of 430° C. and a fluxing oxide content of 30.8%. Glass frit B has a softening point of 600° C. and a fluxing oxide content of 5.1%. Glass fibers A, B and C have softening points of 580° C., 650° C. and 532° C., respectively and fluxing oxide contents of 12-15%. Di(t-butylperoxyisopropyl) benzene peroxide was included in the compositions for effecting thermal crosslinking. All compositions listed in this example are given in % wt/wt.

TABLE 2

| Components | (% wt/wt) |
|---|---|
| Ethylene propylene rubber | 27 |
| Silicone polymer | 8 |
| Muscovite mica | 20 |
| Glass frit B | 2 |
| Clay | 28 |
| Talc | 10 |
| Zinc oxide | 2 |
| Peroxide | 2 |
| Antioxidants, coagents | 1 |
| Total | 100 |
| Total Flux (%) | 2.8 |
| Fluxing oxide as a percent of residue | 4.6 |

### Example 3.1

Specimens of Composition X for strength testing were made with dimensions 50 mm×14 mm×3 mm and thermally crosslinked. For comparison, test specimens were similarly prepared using a commercially available silicone-based material (Composition Y), which also formed a ceramic material when heated. The samples were heated together under slow firing conditions and then cooled. The flexural strength of ceramic formed and change in linear dimension, determined as described above, are shown in Table 3.

TABLE 3

| | | Change in Linear |
|---|---|---|
| Compositions | Flexural Strength (MPa) | Dimensions (%) |
| Composition X | 5.9 | −1.6 |
| Composition Y | 4.2 | −4.9 |

The results obtained from flexural strength measurements show that Composition X has a higher flexural strength than the silicone-based composition (Y) after firing in air at 1000° C.

Shape retention is a critical factor in many applications for these types of materials, for example in electrical cable insulation. Measurements of change in linear dimension after firing at 1000° C. in air showed that Composition X had superior shape retention properties in comparison to Composition Y.

### Example 3.2

A 35 mm² compacted copper conductor was insulated with 1.2 mm wall thickness of Composition X by an extrusion process. The insulated conductor was then sheathed with a thermoplastic flame retardant halogen free material to a wall thickness of 1.4 mm. Three samples of the cable, approximately 2.5 metres long, were installed on a ladder type cable tray in an “S” configuration with bend ratios of 10 times the cable diameter. The tray was mounted on a concrete slab and used to form the top of a pilot furnace capable of following the standard temperature-time curve of the Australian Standard AS1540.3. Each sample cable was connected to a three phase electrical supply such that the cables were on different phases. In each circuit was a 60W light bulb and a 4A fuse. The line voltage was 240V AC. The test was started and continued for 121 minutes, at which time the temperature in the furnace was approximately 1,050° C. At the completion of this time, the circuit integrity of all of the samples was maintained. A water jet spray was then trained on the cables and circuit integrity continued to be maintained.

### Example 3.3

Composition X was modified by adding small amounts of various inorganic additives in the proportions outlined in the table below. The inorganic additives included glass fibre, glass frit and alumino-silicate fibre. Composition X and the modified versions were thermally crosslinked (170° C., 30 minutes, 7 MPa) into flat sheets 2 mm thick. Rectangular samples of dimensions 19 mm×32 mm were cut out of the sheets and subjected to slow firing conditions. After cooling, the samples were tested for water resistance by placing a drop of water on the sample surface. The material was deemed to be water resistant if a drop of water remained on the sample surface for more than three minutes without any visual sign of absorption. The material was not considered water resistant if the water drop was completely absorbed in less than three minutes. The results of this test are shown in Table 4.

TABLE 4

| | Water |
|---|---|
| Composition | Resistant |
| Composition X | No |
| Composition X/Glass fibre A (98:2) | Yes |
| Composition X/Glass fibre A/alumino-silicate fibre (96:2:2) | Yes |
| Composition X/Glass fibre B (98:2) | Yes |
| Composition X/Glass frit A (98:2) | Yes |
| Composition X/Glass frit A/alumino-silicate fibre (96:2:2) | Yes |

A water drop placed on a fired sample of unmodified Composition X was absorbed instantly. From visual inspection the fired samples of other compositions containing the inorganic additives had a glassy, shiny surface layer.

### Example 3.4

Six samples corresponding to the six compositions in the previous example were sectioned such that their thickness was reduced from 2 mm to 1 mm. Samples were then subjected to slow firing conditions. After cooling they were tested for water resistance in the same manner described in the preceding example. In all six cases the samples absorbed a drop of water placed on their surface in less than one minute, indicating a lack of water resistance. A comparison with the results in the previous example shows that sample thickness is a factor in developing water resistance.

### Example 3.5

(A)

Sections of 1.5 mm² copper wire were insulated with Composition X and modifications to this composition as outlined in Tables 5 and 6. The wall thicknesses were set at 1.2 mm and 0.6 mm to obtain cables with thick and thin insulation layers. Insulated cables were put together to form twisted pairs. Each twisted pair was exposed to a Bunsen burner flame for 10 minutes. The burner and cable were configured so that the peak temperature at the flame-sample interface was measured at 1020° C. The cable was allowed to cool and water was dripped across the portion of the twisted pair to assess the time taken for the circuit to short. During the burner and water test the resistance between the two wires in the twisted pair was monitored using a 500 V DC test unit. Failure in either test was deemed to be the measured resistance dropping to approximately 0 MΩ at any point in the test. The compositions and their performance in the tests for thick insulation layers are shown in Table 5 and for thin insulation layers are shown in Table 6

TABLE 5

| | Burner | Water Test | |
|---|---|---|---|
| | Test | (time | |
| Composition | (pass/fail) | to short) | |
| Composition X | Pass | <30 | seconds |
| Composition X/alumino-silicate fibre | Pass | >3 | minutes |
| (99:1) | | | |
| Composition X/Glass frit A (99:1) | Pass | >3 | minutes |
| Composition X/alumino-silicate fibre/Glass | Pass | >3 | minutes |
| frit A (99:0.5:0.5) | | | |

The results in Table 5 showed that additions of glass frit and/or alumino-silicate fibre in amounts totalling no more than 1% wt/wt imparted good water resistance properties to Composition X. Composition X, without any additions, had almost negligible water resistance, with a short circuit occurring in less than 30 seconds after water contacted the cable.

TABLE 6

| | | Water | |
|---|---|---|---|
| | Burner | Test | |
| | Test | (time to | |
| Composition | (pass/fail) | short) | |
| Composition X | Pass | <30 | seconds |
| Composition X/alumino-silicate fibre/Glass | Pass | <30 | seconds |
| frit A (98.5:0.5:1) | | | |
| Composition X/alumino-silicate fibre/Glass | Pass | <1 | minute |
| fibre A (97:1:2) | | | |
| Composition X/alumino-silicate fibre/Glass | Pass | <30 | seconds |
| fibre A (96:1:3) | | | |
| Composition X/alumino-silicate fibre/Glass | Pass | <30 | seconds |
| fibre A/Glass frit A (94:1:3:2) | | | |
| Composition X/alumino-silicate fibre/Glass | Pass | <30 | seconds |
| fibre C (94:1:5) | | | |

The results in Table 6 showed that when a change from 1.2 mm to 0.6 mm wall thicknesses was made, no tested composition exhibited acceptable water resistance. Again, this demonstrates that the thickness of the sample is a factor in developing water resistance.

(B)

In order to improve the water resistance of thin wall (0.6 mm) cables, an addition of alumino silicate fibre and mica were made to Composition X to give a new composition consisting of Composition X/alumino silicate fibre/mica (94:1:5). The fluxing oxide content of the residue obtained under slow firing conditions was 5.1%. The composition was formed into thin wall twisted pair cables and tested in the burner according to the procedure described in the previous example. The wire passed the burner test and the time to short in the water test was greater than 3 minutes.

### Example 3.6

Fired 2 mm thick samples of Composition X modified with inorganic additives to improve water resistance were analysed by scanning electron microscopy and microprobe analysis in order to assess the reason for their water resistance. Micrographs of the sample cross-section showed that a dense glassy layer ranging up to 15 μm in thickness was present at the surface. This glassy film 20 overlays the porous bulk of the material, protecting it from water absorption. Microprobe mapping analysis of a cross-section of the sample showed that this dense glassy layer is rich in potassium, sodium and silica.

### Example 4

A composition with an EPDM polymer (20%), talc (30%), muscovite mica (29%) and processing aids and stabilisers was prepared on a two roll mill. At the completion of mixing, it was separated into two equal portions. One portion was returned to the two roll mill, and 2% of dicumyl peroxide was added. The two portions were then placed separately into picture frame moulds and pressed at 1,000 kPa and 170° C. for 30 minutes. At the end of this period, the press was cooled while maintaining pressure, and after the temperature had reduced to 50° C., the pressure was reduced and the samples removed. The end result was two sheets of material that had undergone the same heat history, but one had been crosslinked while the other was thermoplastic.

Samples of dimensions 38 mm×13 mm were cut from the sheets, and the dimensions accurately recorded. The samples were subjected to slow firing conditions and then the samples were removed from the furnace and allowed to cool to ambient temperature. The dimensions of the ceramic residue formed (fluxing oxide content 6.6%) were then accurately re-measured and the change in linear dimension calculated.

It was found that the thermoplastic version showed less surface disruption than the crosslinked version, expanded less in thickness, but slightly more in length and width. This illustrates that crosslinking of the composition is not essential to achieving an acceptable performance in net shape retention after exposure to 1,000° C.

### Example 5

Compositions based on a representative range of different polymers combined with inorganic filler systems selected from Table 7 were prepared and their behaviour when fired under fast or slow firing conditions was determined.

TABLE 7

| Filler system | A | B | C | D | E | F |
|---|---|---|---|---|---|---|
| Clay | | 31.7 | | | | 16.2 |
| Clay (calcined) | 15.2 | 25.4 | 14.7 | 21.5 | 17.5 | |
| Talc | 36.2 | | 35 | 32.9 | 34.9 | 38.4 |
| Muscovite mica | 45.5 | 39.7 | 44 | 38.7 | 41.5 | 43.1 |
| Zinc borate | 3.1 | | 3 | 6.9 | 6.1 | |
| Glass frit | | 3.2 | 3.3 | | | 2.3 |

Some different ways of making compositions disclosed in this patent are exemplified below.

(A) From Monomers/Reactive Difunctional Compounds

(i)

A composition containing filler system A (58.9%) and an acrylic polymer was prepared by mixing the inorganic components with a mixture of acrylate monomers and peroxide then heating the mixture in a mould at 80° C. for 2 hours. The ceramic formed (fluxing oxide content 7.2%) under the fast firing conditions had a linear dimension change of 0.9% and a flexural strength of 0.5 MPa.

(ii)

A composition containing filler system E (62.2%) and a polyimide was prepared by partly reacting equimolar amounts of pyromellitic dianhydride with oxydianaline bis(4-aminophenyl)ether polymer, adding the filler system and then heating the cast solutions for one hour periods at 100° C., 150° C., 200° C. and then 250° C. The ceramic formed (fluxing oxide content 7.9%) under the fast firing conditions had linear dimension change 3.4% and a flexural strength of 5.3 MPa.

(B) From Thermoplastic Polymers and Rubbers

The compositions in Table 8 were prepared by incorporating the indicated filler systems into the thermoplastic polymer (combined with other additives where indicated) using an internal mixer, an extruder or a two-roll mill. The compositions containing SBR, SBS and NBR also incorporated peroxides and were subsequently cured by heating at elevated temperatures to form elastomeric compositions which were subsequently fired.

TABLE 8

| | | | | Percent | | |
|---|---|---|---|---|---|---|
| | Percent | | | fluxing | Percent | |
| | other | Filler | Firing | oxide | linear | Flexural |
| Polymer | addi- | system | con- | content of | dimension | strength |
| (%) | tives | (%) | ditions | residue | change | (MPa) |
| PE (25)^{b} | 4.7 | B (63) | Fast | 5.2 | −2.3 | 1.7 |
| | | | Slow | | −1.6 | 1.4 |
| PP (38) | 2 | C (60) | Fast | 8 | 1.4 | 0.4 |
| | | | Slow | | 2.2 | 0.6 |
| EVA (38) | 2 | C (60) | Slow | 8 | 0.9 | 0.7 |
| EMA (40) | — | C (60) | Fast | 8 | 4.5 | 1.3 |
| | | | Slow | | −3.4 | 0.8 |
| SBS (30) | 12 | A (58) | Fast | 7.2 | −3.2 | 3 |
| | | | Slow | | −2.7 | 3.5 |
| SBR (30) | 12 | A (58) | Fast | 7.2 | 1.2 | 2.8 |
| | | | Slow | | −2.4 | 1 |
| NBR (30) | 12 | A (58) | Fast | 7.2 | −1.2 | 1.3 |
| | | | Slow | | −0.8 | 3.8 |
| PVC (20) | (15.0) | F (65) | Slow | (9.1) | (−2.6) | 8.3 |

^{b}In addition the composition contains 7.3% silicone polymer

(C) From Prepolymers and Resins

The thermoset compositions in Table 9 were prepared by incorporating the indicated filler systems into the prepolymers or resins and the systems were crosslinked/cured using the conditions indicated.

TABLE 9

| | | | | Percent | | |
|---|---|---|---|---|---|---|
| | | | | fluxing | | |
| | Crosslinking/ | | | oxide | Percent | |
| | curing | Filler | | content | linear | Flexural |
| | agent | system | Firing | of | dimension | strength |
| Prepolymer/resin (%) | (conditions) | (%) | conditions | residue | change | (MPa) |
| Epoxy resin with amine | (40° C./3 h | A (59.5) | Fast | 7.2 | 0.8 | 1.4 |
| hardner (40.5) | and | | Slow | | −0.7 | 2.1 |
| | 80° C./1 h) | | | | | |
| Vinyl ester resin (40) | Peroxide | A (60) | Fast | 7.2 | −1 | 1.8 |
| | (80° C./2 h) | | Slow | | −1 | 2.7 |
| Polyester resin (44.4) | Peroxide | A (55.6) | Slow | 7.2 | −3.6 | 1.5 |
| | (80° C./2 h) | | | | | |
| Phenolic resin (44.2)*** | (140° C./1 h) | A (55.8) | Fast | 7.2 | −3.9 | 3.6 |
| | | | Slow | | −2.6 | 5.2 |
| Flexible Foamed | (25° C./3 h) | A (60) | Fast | 7.2 | −0.5 | 0.9 |
| Polyurethane (40) | | | Slow | | −2.6 | 1 |
| Cast Polyurethane (40) | (25° C./3 h) | A (60) | Fast | 7.2 | 0.4 | 3.6 |
| | | | Slow | | −0.1 | 1.2 |

***Among the best examples for near-net shape retaining compositions.

(D) From Polymer Emulsions/Dispersions

The compositions in Table 10 were prepared by incorporating the indicated filler systems into the emulsions/dispersions and drying the resulting mixture (typically 3 days at 70° C.) to remove the water. The percentage polymer in the compositions is the weight of dry polymer present.

TABLE 10

| | | | Percent | | |
|---|---|---|---|---|---|
| Polymer | | | fluxing | | |
| from | | | oxide | Percent | |
| emulsion/ | Filler | | content | linear | Flexural |
| dispersion | system | Firing | of | dimension | strength |
| (%) | (%) | conditions | residue | change | (MPa) |
| PVAc | D (70) | Fast | 7.9 | −2.5 | 2.4 |
| emulsion (30) | | Slow | | −2.1 | 5.5 |
| Acrylic | C (80) | Fast | 8 | 0.3 | 3.5 |
| dispersion (20) | | Slow | | 0.5 | 5.4 |
| Polyurethane | C (60) | Fast | 6.7 | 1.8 | 0.4 |
| dispersion (40) | | Slow | | 2.1 | 0.7 |

### Example 6

Compositions Y1 to Y11, given in Table 11, contain ethylene propylene rubber or a combination of ethylene propylene rubber and silicone polymer where the silicone polymer is in the minor amount. These were prepared by mixing the polymer(s) with the respective filler and additive combination using a two roll mill as described earlier. Specimens of nominal dimensions 30 mm×13 mm×1.7 mm, made from these compositions, were fired under the slow and fast firing conditions. For each composition, the change in linear dimension caused by firing and the flexural strength of the resultant ceramic, determined as described earlier, are given in Table 11.

TABLE 11

| | | | | | | | Percent | | Flexural |
|---|---|---|---|---|---|---|---|---|---|
| | | | | | | | fluxing | Percent | strength |
| | Percent | | Percent | | Percent | | oxide | linear | of |
| | ethylene | Percent | other | Percent | other | | content | dimension | ceramic |
| | propylene | silicone | organic | silicate | inorganic | Firing | of | change | formed |
| Composition | rubber | polymer | additives | fillers | fillers | condition | residue | on firing | (MPa) |
| Y1* | 22.0 | | 12.0 | 64.0 | 2.0 | Fast | 7.2 | −3.1 | 2.9 |
| | | | | | | Slow | | −4.2 | 9.7 |
| Y2*\hat{ }\hat{ }\hat{ } | 22.0 | | 12.0 | 64.0 | 2.0 | Fast | 7.2 | −2.7 | 5.8 |
| | | | | | | Slow | | −0.9 | 7.4 |
| Y3 | 30.0 | | 12.0 | 56.2 | 1.8 | Fast | 7.2 | −2.5 | 2.4 |
| | | | | | | Slow | | 0.5 | 4.3 |
| Y4 | 42.0 | | 12.0 | 44.6 | 1.4 | Fast | 7.2 | −2.1 | 0.3 |
| | | | | | | Slow | | ** | |
| Y5 | 32.0 | 10.0 | 6.0 | 43.2 | 8.8 | Fast | 7.2 | −3.4 | 4.3 |
| | | | | | | Slow | | ** | |
| Y6^{##} | 13.0 | | 12.0 | 72.7 | 2.3 | Fast | 7.2 | −2.7 | 13.9 |
| | | | | | | Slow | | −2.8 | 20.4 |
| Y7 | 27.0 | 13.0 | 12.0 | 24.0 | 24.0 | Fast | 4.2 | −4.5 | 1 |
| | | | | | | Slow | | ** | |
| Y8 | 22.0 | 11.0 | 6.0 | 45.0 | 16.0 | Fast | 6.6 | −9.3 | 7 |
| | | | | | | Slow | | −9 | 9.9 |
| Y9\hat{ }\hat{ }\hat{ } | 22.0 | 4.0 | 12.0 | 60.0 | 2.0 | Fast | 7.3 | −1.8 | 3.1 |
| | | | | | | Slow | | −0.8 | 1.8 |
| Y10 | 22.0 | | 12.0 | 62.0 | 4.0 | Fast | 9.5 | −3.5 | 5.7 |
| | | | | | | Slow | | −6.2 | 13.5 |
| Y11 | 22.0 | | 12.0 | 66.0 | | Fast | 1.6 | 0.8 | 2.1 |

| | |
|---|---|
| Slow | ** |

*These compositions were chemically identical. The average particle size of major mineral filler in composition Y1 was approximately 55 microns while the average particle size of major mineral filler in composition Y2 was approximately 160 microns.
** Could not test for dimensional change and strength due to non-uniform deformation during firing.
^{##}Processability using two-roll mill was poor.
\hat{ }\hat{ }\hat{ }Among the best examples for near-net shape retaining compositions

### Example 7

Composition FL, given in Table 12, were prepared by mixing the ethylene propylene rubber with the respective filler and additive combination using a two roll mill as described earlier. Compositions FL1 to FL4, given in Table 12, were prepared by adding. 2% of a fluxing oxide to composition FL and mixing again. Specimens of nominal dimensions 30 mm×13 mm×1.7 mm, made from these compositions were fired under the slow and fast firing conditions. For each composition, the change in linear dimension caused by firing and the flexural strength of the resultant ceramic, determined as described earlier, are given in Tables 12.

TABLE 12

| | | | | | | Percent | | flexural |
|---|---|---|---|---|---|---|---|---|
| | | | | | | fluxing | Percent | strength |
| | Percent | Percent | | Added | | oxide | linear | of |
| | ethylene | other | Percent | fluxing | | content | dimension | ceramic |
| | propylene | organic | silicate | oxide⁺⁺ | Firing | of | change on | formed |
| Composition | rubber | additives | fillers | (%) | condition | residue | firing | (MPa) |
| FL | 22.5 | 12.2 | 65.3 | — | Fast | 3.4 | −0.7 | 1.1 |
| | | | | | Slow | | −0.8 | 1.4 |
| FL1 | 22.0 | 12.0 | 64.0 | Li₂O (2) | Fast | 6.4 | −4.0 | 6.1 |
| | | | | | Slow | | −3.5 | 5.4 |
| FL2 | | | | Na₂O (2) | Fast | | −2.3 | 2.6 |
| | | | | | Slow | | −1.9 | 6.0 |
| FL3 | | | | K₂O (2) | Fast | | 0.1 | 1.9 |
| | | | | | Slow | | −0.4 | 3.2 |
| FL4 | | | | B₂O₃ (2) | Fast | | −2.7 | 2.8 |
| | | | | | Slow | | −3.8 | 2.8 |

⁺⁺Added as oxide or carbonate in an amount that produces 2% oxide by thermal decomposition.

### Example 8

Compositions FX1 to FX3, given in Table 13, were prepared by mixing the ethylene propylene rubber with the respective filler and additive combination using a two roll mill as described earlier. FX1 is a composition in accordance with the specifications for the fire resistant material of the present invention. FX2 and FX3 are comparative example compositions containing higher amounts of fluxing oxides and lower amounts of silicate mineral fillers than recommended for the fire resistant material of the present invention. Specimens of nominal dimensions 30 mm×13 mm×1.7 mm, made from these compositions, were placed on a rectangular piece of refractory so that their long axis was perpendicular to one edge of the supporting refractory block and a 13 mm long portion of each specimen was projecting out from the edge of the supporting refractory block.

They were then heated at 12° C. per minute to 830° C. and 1000° C. and maintained at these temperatures for 30 minutes in air. At both temperatures, the specimens of composition FX1 did not fuse and produced a coherent self-supporting porous ceramic that retained the shape of the specimen prior to exposure to elevated temperatures. The change in dimension of the specimens of composition FX1 along the length and the width was less than 3%. At both temperatures, the specimens of compositions FX2 and FX3 fused and the unsupported span bent over the edge of the refractory support to take a near vertical position showing their inability to retain shape or support own weight. When heated to 1100° C. the specimens of compositions FX2 and FX3 fused completely to form a glassy material that flowed on and along the sides of the refractory support whereas the specimens of composition FX1 remained rigid.

TABLE 13

| | Percent | Percent | | Percent | Percent |
|---|---|---|---|---|---|
| | ethylene | other | Percent | other | fluxing |
| Compo- | propylene | organic | silicate | inorganic | oxide content |
| sition | rubber | additives | fillers | fillers | of residue |
| FX1 | 22.0 | 12.0 | 64.0 | 2.0 | 72 |
| FX2 | 22.7 | 15.0 | 18.2 | 44.0 | 65.6 |
| FX3 | 22.2 | 14.0 | 17.8 | 46.0 | 77.0 |

### Example 9

Compositions OF1 to OF6, given in Table 14, were prepared by mixing the ethylene propylene rubber with the respective filler and additive combination using a two roll mill as described earlier. Composition OF7, given in Table 14, was prepared by adding 4% of alumina fibres to composition OF6 and mixing again. Specimens of nominal dimensions 30 mm×13 mm×1.7 mm, made from these compositions were fired under the slow or fast firing conditions. For each composition, the change in linear dimension caused by firing and the flexural strength of the resultant ceramic, determined as described earlier, are given in Table 14. Of the samples shown in Table 14, OF1 and OF2 are most suitable for use as an insulating layer and/or sheathing layer on a cable.

TABLE 14

| | | | | | | | Percent | | Flexural |
|---|---|---|---|---|---|---|---|---|---|
| | | | | | | | fluxing | Percent | strength |
| | Percent | Percent | | | | | oxide | linear | of |
| | ethylene | other | Percent | Percent | Other | | content | dimension | ceramic |
| | propylene | organic | silicone | silicate | inorganic | Firing | of | change on | formed |
| Composition | rubber | additives | polymer | fillers | fillers (%) | condition | residue | firing | (MPa) |
| OF1 | 19.0 | 16.0 | 5.0 | 40.0 | ATH* | Fast | 4.7 | −0.3 | 1.1 |
| | | | | | (10), | | | | |
| | | | | | CaCO₃ | | | | |
| | | | | | (10) | | | | |
| OF2 | 19.0 | 16.0 | 6.0 | 30.0 | ATH* | Fast | 4.7 | −3.9 | 2.2 |
| | | | | | (29) | | | | |
| OF3 | 22.0 | 12.0 | | 64.0 | BaO (2) | Fast | 3.3 | −1.1 | 1.9 |
| | | | | | | Slow | | −1.3 | 2.6 |
| OF4 | | | | | CaO (2) | Fast | | −1.6 | 1.5 |
| | | | | | | Slow | | −1.5 | 1.9 |
| OF5 | | | | | Fe₂O₃ (2) | Fast | | −1.0 | 1.4 |
| | | | | | | Slow | | −1.3 | 1.1 |
| OF6 | 25.0 | 4.0 | 7.0 | 61.0 | 3.0 | Slow | 5.3 | −2.4 | 5.2 |
| OF7 | 24.0 | 3.8 | 6.7 | 58.6 | 6.9^{##} | Slow | 5.0 | −1.6 | 5.8 |

*Aluminium tri-hydrate
^{##}Includes 4% alumina fibres

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A fire resistant composition for forming a fire resistant ceramic at elevated temperatures, the composition comprising:
at least 15% by weight based on the total weight of the composition of a polymer base composition comprising at least 50% by weight of an organic polymer;
at least 15% by weight based on the total weight of the composition of a silicate mineral filler; and
at least one source of fluxing oxide which is optionally present in said silicate mineral filler,
wherein after exposure to an elevated temperature experienced under fire conditions, a fluxing oxide is present in an amount of from 1 to 15% by weight of the residue.

2. The fire resistant composition of claim 1, wherein the silicate mineral filler is present in an amount of at least 25% by weight based on the total weight of the composition.

3. The fire resistant composition of claim 1, wherein the fluxing oxide is present in the residue in an amount of 1-10 wt. % after exposure to said elevated temperatures.

4. The fire resistant composition of claim 1, wherein the fluxing oxide is present in the residue in an amount of 2-8 wt. % of the residue after exposure to said elevated temperature.

5. The fire resistant composition of claim 1, wherein the weight of the residue after firing is at least 40% of the fire resistant composition.

6. A fire resistant composition of claim 1, wherein the composition forms a self-supporting structure when heated to an elevated temperature experienced under fire conditions.

7. The fire resistant composition of claim 1, wherein the fluxing oxide is generated by the silicate mineral filler being heated to an elevated temperature.

8. The fire resistant composition of claim 1, wherein the fire resistant composition further comprises at least one additive selected from the group of a fluxing oxide and precursors of fluxing oxides.

9. The fire resistant composition of claim 8, wherein the composition comprises at least two different fluxing oxides or precursors to fluxing oxides which form liquid phases at different temperatures.

10. A fire resistant composition according to claim 8, wherein the at least one of fluxing oxide precursor comprises one or more materials selected from the group consisting of borates, metal hydroxides, metal carbonates and glasses.

11. A fire resistant composition according to claim 8, wherein the fluxing oxide added or derived from precursors comprises at least one oxide of an element
selected from the group consisting of lead, antimony, boron, lithium, potassium, sodium, phosphorous and vanadium.

12. A fire resistant composition according to claim 1, wherein the composition has less than 10% change in linear dimension after heating at an elevated temperature experienced under fire conditions.

13. A fire resistant composition according to claim 1, wherein the composition has less than 5% change in linear dimension after heating at an elevated temperature experienced under fire conditions.

14. A fire resistant composition according to claim 1, wherein the composition remains coherent when heated to temperatures of less than 1050° C. for minutes.

15. The fire resistant composition of claim 1, wherein after exposure to an elevated temperature experienced under fire conditions, the fire resistant composition has a flexural strength of at least 0.3 MPa.

16. A fire resistant composition of claim 1, wherein the organic polymer is selected from the group of thermoplastic polymers, thermoset polymers and elastomers.

17. A fire resistant composition of claim 1, wherein the organic
polymer comprises at least one of homopolymer or copolymer or elastomer or resin of polyolefins, ethylene-propylene rubber, ethylene-propylene terpolymer rubber (EPDM), chlorosulfonated polyethylene and chlorinate polyethylene, vinyl polymers, acrylic and methacrylic polymers, polyamides, polyesters, polyimides, polyoxymethylene acetals, polycarbonates, polyurethanes, natural rubber, butyl
rubber, nitrile-butadiene rubber, epichlorohydrin rubber, polychloroprene, styrene polymers, styrene-butadiene, styrene-isoprene-styrene,styrene-butadiene-styrene, styrene-ethylene-butadiene-styrene, epoxy resins, polyester resins, vinyl ester resins, phenolic resins, and melamine formaldehyde resins.

18. The fire resistant composition of claim 1, wherein the polymer base composition comprises from 15 to 75 wt. % of the formulated fire resistant composition.

19. The fire resistant composition of claim 1, wherein the silicate mineral filler is at least one selected from the group consisting of alumino-silicates, alkali alumino-silicates, magnesium silicates and calcium silicates.

20. The fire resistant composition of claim 1, comprises an additional inorganic filler selected from the group consisting of silicon dioxide and metal oxides of aluminium, calcium, magnesium, zircon, zinc, iron, tin and barium and inorganic fillers which generate one or more of these oxides when they thermally decompose.

21. The fire resistant composition of claim 1, wherein the polymer base composition further comprises a silicone polymer.

22. The fire resistant composition of claim 21, wherein the weight ratio of organic polymer to silicone polymer is within the range of 5:1 to 2:1.

23. The fire resistant composition of claim 1, further comprising a silicone polymer in an amount of from 2 to 15 wt. % based on the total weight of the formulated fire resistant composition.

24. A fire resistant composition according to claim 1, wherein the 5 elevated temperature experienced under fire conditions is 1000° C. for 30 minutes.

25. A fire resistant composition according to claim 1, wherein:
20 to 75% by weight of said polymer base composition wherein said composition further comprises a silicone polymer;
at least 15% by weight of an inorganic filler wherein said inorganic filler comprises mica and a glass additive; and
wherein the fluxing oxide in the residue is derived from glass and mica wherein, the ratio of mica: glass is in the range of from 20:1 to 2:1.

26. A fire resistant composition according to claim 25, wherein the polymer base composition comprises organic polymer and silicone polymer in the weight ratio of from 5:1 to 2:1;
said inorganic filler comprises 10 to 30% by weight of the total composition of mica and 20 to 40% by weight of the total composition of an additional inorganic filler.

27. A fire resistant composition of claim 1, wherein the fluxing oxide is present in the residue in an amount in excess of 5% by weight of the residue, said fluxing oxide forming a glassy surface layer on the ceramic formed on exposure to fire, said glassy surface layer forming a barrier layer which increases the resistance to passage of water and gases.

28. A fire resistant cable comprising a conductive element and at least one insulating layer and/or sheathing layer made of a fire resistant composition for providing a fire resistant ceramic under fire conditions, the fire resistant composition comprising:
at least 15% by weight based on the total weight of the composition of a polymer base composition comprising at least 50% by weight of an organic polymer;
at least 15% by weight based on the total weight of the composition of a silicate mineral filler; and
at least one source of fluxing oxide which is optionally present in said silicate mineral filler,
wherein after exposure to an elevated temperature experienced under fire conditions, a fluxing oxide is present in an amount from 1 to 15% by weight of the residue.

29. A fire resistant cable of claim 28, wherein the silicate mineral filler is present in an amount of at least 25% by weight based on the total weight of the composition.

30. The fire resistant cable of claim 28, wherein the fluxing oxide is present in the residue in the fire resistant composition in an amount of 1-10 wt. % after exposure to said elevated temperatures.

31. The fire resistant cable of claim 28, wherein the fluxing oxide is present in the residue of the fire resistant composition in an amount of 2-8 wt. % after exposure to said elevated temperature.

32. The fire resistant cable of claim 28, wherein the weight of the residue after firing is at least 40% of the fire resistant composition.

33. A fire resistant cable of claim 28, wherein the composition forms a selfsupporting structure when heated to an elevated temperature experienced under fire conditions.

34. The fire resistant cable of claim 28, wherein the fluxing oxide is generated by the silicate mineral filler being heated to an elevated temperature.

35. The fire resistant cable of claim 28, wherein the fire resistant composition further comprises at least one additive selected from the group of fluxing oxides and precursors to fluxing oxides.

36. The fire resistant cable of claim 35, wherein the fire resistant composition 5 comprises at least two different fluxing oxides or precursors to fluxing oxides which form liquid phases at different temperatures.

37. A fire resistant cable according to claim 35, wherein at least one of fluxing oxide precursor comprises one or more materials selected from the group consisting of borates, metal hydroxides, metal carbonates and glasses.

38. A fire resistant cable according to claim 35, wherein the fluxing oxide added or derived from a precursor to a fluxing oxide comprises at least one selected from the group consisting of an oxide of an element selected from the group consisting of boron, lithium, potassium, sodium, phosphorous vanadium, lead and antimony.

39. A fire resistant cable according to claim 28, wherein the composition has less than 10% change in linear dimension after heating at an elevated temperature experienced under fire conditions.

40. A fire resistant cable of claim 28, wherein the composition has less than 5% change in linear dimension after heating at an elevated temperature experienced under fire conditions.

41. A fire resistant cable according to claim 28, wherein the fire resistant composition remains coherent when heated to temperatures of less than 1050° C. for 30 minutes.

42. A fire resistant cable of claim 28, wherein the organic polymer is a thermoplastic and crosslinked olefin based polymer selected from the group of homopolymers of olefins, copolymers or terpolymers of one or more olefins and a blend of homopolymers, copolymers and terpolymers.

43. A fire resistant cable of claim 28, wherein the organic polymer comprises at least one of homopolymer or copolymer or elastomer or resin of polyolefins, ethylene-propylene rubber, ethylene-propylene terpolymer rubber (EPDM), chlorosulfonated polyethylene and chlorinate polyethylene, vinyl polymers, acrylic and methacrylic polymers, polyamides, polyesters, polyimides, polyoxymethylene acetals, polycarbonates, polyurethanes, natural rubber, butyl rubber, nitrile-butadiene rubber, epichlorohydrin rubber, polychloroprene, styrene polymers, styrene-butadiene, styrene-isoprene-styrene,styrene-butadiene-styrene, styrene-ethylene-butadiene-styrene, epoxy resins, polyester resins, vinyl ester resins, phenolic resins, and melamine formaldehyde resins.

44. A fire resistant cable of claim 28, wherein the fire resistant composition comprises an additional inorganic filler selected from the group consisting of silicon dioxide and metal oxides of aluminium, calcium, magnesium, zircon, zinc, iron, tin and barium and inorganic fillers which generate one or more of these oxides when they thermally decompose.

45. A fire resistant cable comprising a conductive element and at least one insulating layer and/or sheathing layer made of a fire resistant composition of claim 1.

46. A fire resistant cable of claim 28, wherein the polymer base composition in the fire resistant composition further comprises a silicone polymer.

47. A fire resistant product formed from the composition of claim 1.

48. The fire resistant product of claim 47, used in passive fire protection applications and general engineering applications where passive fire protection properties are required.
